(19) United States
(12) Patent Application Publication
(10) Pub. No.: US 2014/0195939 A1
(43) Pub. Date: Jul. 10, 2014

(54) INFORMATION DISPLAY APPARATUS

(71) Applicant: Sharp Kabushiki Kaisha, Osaka (JP)

(72) Inventor: Kouji MIYAKE, Osaka-shi (JP)

(73) Assignee: Sharp Kabushiki Kaisha, Osaka (JP)

(21) Appl. No.: 14/148,008

(22) Filed: Jan. 6, 2014

(30) Foreign Application Priority Data
Jan. 9, 2013 (JP) 2013-001646

(51) Int. Cl. G06F 3/0488

(52) U.S. Cl. CPC G06F 3/0488
USPC 715/765

(57) ABSTRACT

Provided is an information display apparatus capable of smoothly carrying out a presentation using a touch panel. The information display apparatus has an edit mode capable of editing an image displayed on the touch panel and a fixing mode for prohibiting editing of the displayed image to maintain the image. The information display apparatus includes a judging portion for judging whether or not a predetermined position of the touch panel is touched, and a mode setting portion for switching the edit mode and the fixing mode each time it is judged that the predetermined position of the touch panel is touched.

### CROSS-NOTING PARAGRAPH

This non-provisional application claims priority under 35 U.S.C. §119(a) on Patent Application No. 2013-001646 filed in JAPAN on Jan. 9, 2013, the entire contents of which are hereby incorporated herein by reference.

### FIELD OF THE INVENTION

The present invention relates to an information display apparatus, and more specifically to an information display apparatus capable of editing display content based on a touch to a touch panel, and the like.

### BACKGROUND OF THE INVENTION

This type of information display apparatus is widely used for a presentation, a meeting, a lesson, a lecture and the like, and has a large-scale touch panel having a touch sensor provided on a display. By displaying an image from an external device or the like on the display and touching the touch panel with a finger of a user, a stylus or the like, it is possible to insert handwritten characters and graphics such as symbols at the touched position.

When an operation mode capable of writing characters and the like (also referred to as an overwrite mode) is set, an application which executes this overwrite mode has an execution right. Therefore, even when the touch panel is touched to indicate apart of display content, a line or the like is written at the touched portion.

Here, when the user desires to use an operation mode different from a current operation mode, an operation for cancelling the current operation mode and an operation for transferring the execution right to an application which executes the different operation mode are required separately, thus being inconvenience. Then, for example, Japanese Laid-Open Patent Publication No. 2004-78367 discloses a technology that an execution right is able to be automatically transferred from an application which executes a current operation mode to a different application with an operation for cancelling the current operation mode omitted.

However, according to Japanese Laid-Open Patent Publication No. 2004-78367, even when the current operation mode is able to be canceled only by the operation for transferring the execution right to the different application, the different operation mode only becomes usable and it is impossible to lock the display content. Therefore, in a case where even though the touch panel is only touched to indicate a part of the display content during a presentation, the execution right is transferred to an application prescribed at the touched portion, and if the mode is in a mode capable of editing the display content, there is a problem that the operation that the user does not intend is executed, such as that a line or the like is written at the touched position, the content which has been input is moved to a different position, or the current display content is shifted to display content of a next page, thus preventing the presentation.

### SUMMARY OF THE INVENTION

The present invention aims to provide an information display apparatus capable of smoothly carrying out a presentation using a touch panel.

An object of the present invention is to provide an information display apparatus having an edit mode capable of editing an image displayed on a touch panel and a fixing mode for prohibiting editing of the displayed image to maintain the image, wherein a judging portion for judging whether or not a predetermined position of the touch panel is touched, and a mode setting portion for switching the edit mode and the fixing mode each time it is judged that the predetermined position is touched are included.

Another object of the present invention is to provide the information display apparatus, wherein a cabinet which holds a periphery of the touch panel is included, and the predetermined position of the touch panel is formed into a belt shape along an outline of the cabinet.

Another object of the present invention is to provide the information display apparatus, wherein the predetermined position of the touch panel is displayed in a different form between the edit mode and the fixing mode.

### BRIEF DESCRIPTION OF THE DRAWINGS

FIG. 1 is a front view of an information display apparatus according to the present invention;

FIG. 2 is a block diagram showing a structure of the information display apparatus according to the present invention;

FIG. 3 is a flowchart explaining an action at the time of switching a mode according to the present invention;

FIG. 4A through FIG. 4C are views explaining mode switching according to the present invention;

FIG. 5A through FIG. 5D are views explaining mode switching according to the present invention; and

FIG. 6A through FIG. 6D are views explaining mode switching according to the present invention.

### PREFERRED EMBODIMENTS OF THE INVENTION

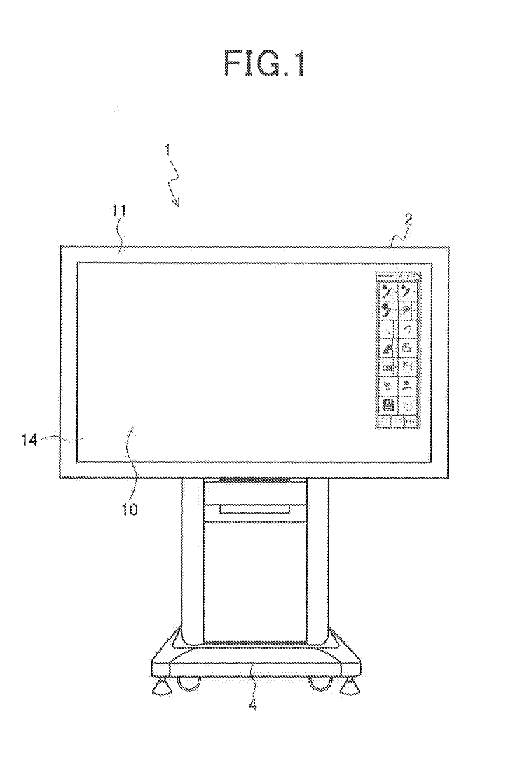

Description will hereinafter be given for an information display apparatus of the present invention with reference to drawings. FIG. 1 is a front view of the information display apparatus according to the present invention. An information display apparatus 1 has a touch panel 2 which is used for an electronic meeting system. The touch panel 2 has a touch sensor described below and, for example, a liquid crystal display, and is provided with a rectangular LCD (Liquid Crystal Display) panel having a liquid crystal layer, a glass substrate and the like, a guard glass, further, a direct backlight in which, for example, LEDs are arranged in a plane, and the like. Note that, the display may be TFT liquid crystal or electronic paper, and the backlight may be configured in an edge light type.

A periphery of a front face and an outer periphery of the touch panel 2 are pressed by a frame-shaped front cabinet 11, and a back face of the touch panel 2 is covered with a box-shaped back cabinet (not shown). Note that, the front cabinet 11 corresponds to a cabinet of the present invention. The touch panel 2 is configured, for example, so as to be able to be installed on the floor of a room or the like with a floor stand 4.

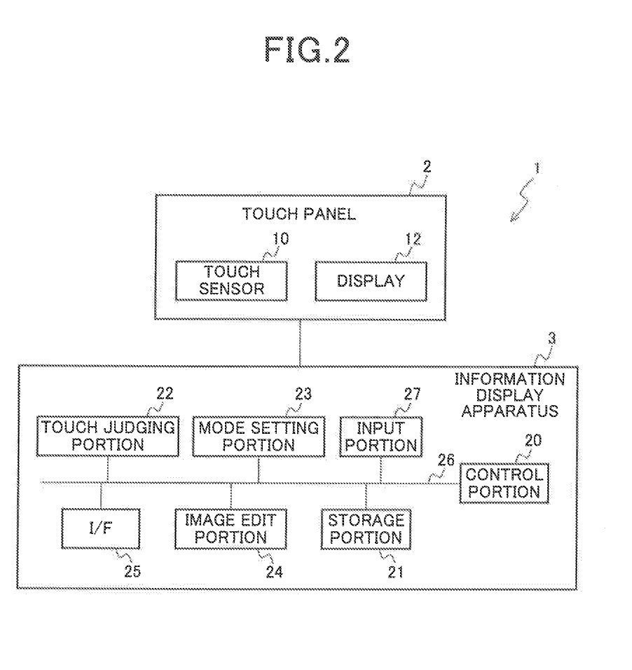

FIG. 2 is a block diagram showing a structure of the information display apparatus according to the present invention. The information display apparatus 1 is composed of the touch panel 2 and an information processing apparatus 3. The touch panel 2 is composed of, for example, a touch sensor 10 of a transparent resistance film type and a liquid crystal display 12 described above, and is formed by providing the touch sensor 10 on the display 12. The touch sensor 10 is a sensor which detects a touch with a finger, a stylus or the like. A detection method may be composed of an infrared camera method, an infrared blocking detection method, an electrostatic capacity method, an electromagnetic induction method or the like.

Based on an instruction from the information processing apparatus 3, for example, an image of material or the like is displayed on the display 12. In the display 12, an orthogonal coordinate system for display is set, and pixels are arranged in a matrix along this coordinate system. A position of a pixel is output to the information processing apparatus 3, and, for example, stored in a storage portion 21.

On the other hand, the touch sensor 10 has a transparent electrode, and an orthogonal coordinate system for input is set in the transparent electrode. This orthogonal coordinate system corresponds to the orthogonal coordinate system for display.

The information processing apparatus 3 has a control portion 20, a touch judging portion 22, a mode setting portion 23, an image edit portion 24, an I/F 25 and the like, in addition to the storage portion 21, which are connected via a bus 26.

The control portion 20 is composed of, for example, one or a plurality of CPUs (Central Processing Units) and the like, and loads, for example, various programs and data stored in a ROM of the storage portion 21 into a RAM to execute the loaded programs in the RAM. Thereby, the entire action of the information display apparatus 1 is controlled based on the instruction content or the like from the user.

In addition, the control portion 20 causes the display 12 to display a GUI (graphical user interface) for operating the information display apparatus 1.

The touch judging portion 22 detects a touched position to the touch panel 2 and a touch action to the touch panel 2, for example, such as single tap or flick. Moreover, the touch judging portion 22 is able to judge, based on the detection result of the touched position and the action, whether or not a predetermined position of the touch panel 2 (described below) is touched, and the like. The detection result and the judgment result are output to the mode setting portion 23. Note that, the touch judging portion 22 corresponds to a judging portion of the present invention.

When receiving the detection result from the touch judging portion 22, the mode setting portion 23 performs a conversion into the above-described orthogonal coordinate system for display to output to the image edit portion 24. Image data by handwriting or the like is stored in the storage portion 21. Note that, an image displayed on the touch panel 2 is also able to be edited, for example, based on input to an input portion 27 from a keyboard in addition to input to the touch panel 2, and the data thereof is also stored in the storage portion 21.

Moreover, the mode setting portion 23, when receiving the judgment result that the predetermined position described above is touched from the touch judging portion 22, as will be described below, switches a current operation mode (for example, an edit mode) into a different mode (for example, a fixing mode), and performs processing in accordance with the operation mode after switching, specifically, when the edit mode is set, gives an instruction of processing prescribed for drawing and the touch operation to the touched position to the image edit portion 24. Note that, the mode setting portion may judge whether or not the predetermined position of the touch panel 2 is touched and the like and switch the operation mode.

In response to a command from the mode setting portion 23, the image edit portion 24 calls image data of material, by handwriting and the like from the storage portion 21, and according to a predetermined program stored in the ROM, synthesizes an image of the material and an image by handwriting and the like on the display 12. Thereby, the user of the information display apparatus 1 is able to see the image after synthesizing on the touch panel 2.

Note that, the control portion 20 is able to be connected to an external device (not shown) such as a multi-functional peripheral or a personal computer (PC) via the I/F 25. For that connection, methods of short-range wireless communication, network connection, serial connection and the like are usable. The information display apparatus 1 may have the PC.

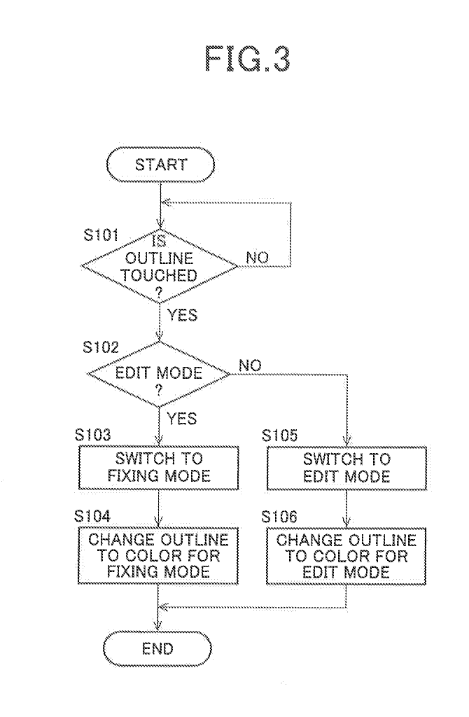

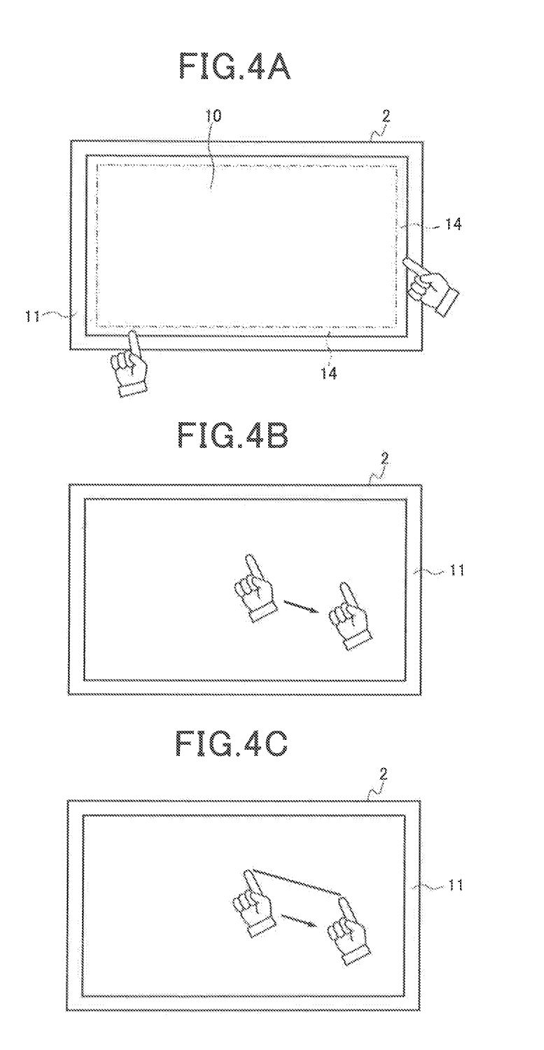

FIG. 3 is a flowchart explaining an action at the time of switching a mode according to the present invention, and FIG. 4A through FIG. 6D are views explaining mode switching according to the present invention.

In the case of editing based on input to the touch panel 2, the touch judging portion 22 judges whether or not the user touches the predetermined position of the touch panel 2, for example, a vicinity of an outline of the touch panel 2 (step S101 of FIG. 3). Specifically, as shown in FIG. 4A, a mode switch button 14 is formed into a belt shape along an outline of the front cabinet 11. This makes it possible to touch the mode switch button 14 no matter what position the user is with respect to the touch panel 2.

When the user touches the mode switch button 14 (YES at step S101 of FIG. 3), the mode setting portion 23 judges whether or not an operation mode which is currently set is an edit mode (step S102). In the case of the edit mode (YES at step S102), the mode setting portion 23 switches to a fixing mode (step S103), and locks display content of the touch panel 2 at the time when the mode switch button 14 is touched.

More specifically, when the fixing mode is set, as shown in FIG. 4B, if the finger of the user continuously touches an area inside of the mode switch button 14, for example, in an obliquely right downward direction from a center position of the touch panel 2, the touch judging portion 22 detects this touched state. However, the mode setting portion 23 does not give an instruction of the processing for the touch panel 2 to the image edit portion 24. As a result, even when continuously touching with the finger, the display content of the touch panel 2 maintains the display content at the time when the fixing mode is set, for example, without adding or deleting a line associated with a touch to the touch panel 2, and the like.

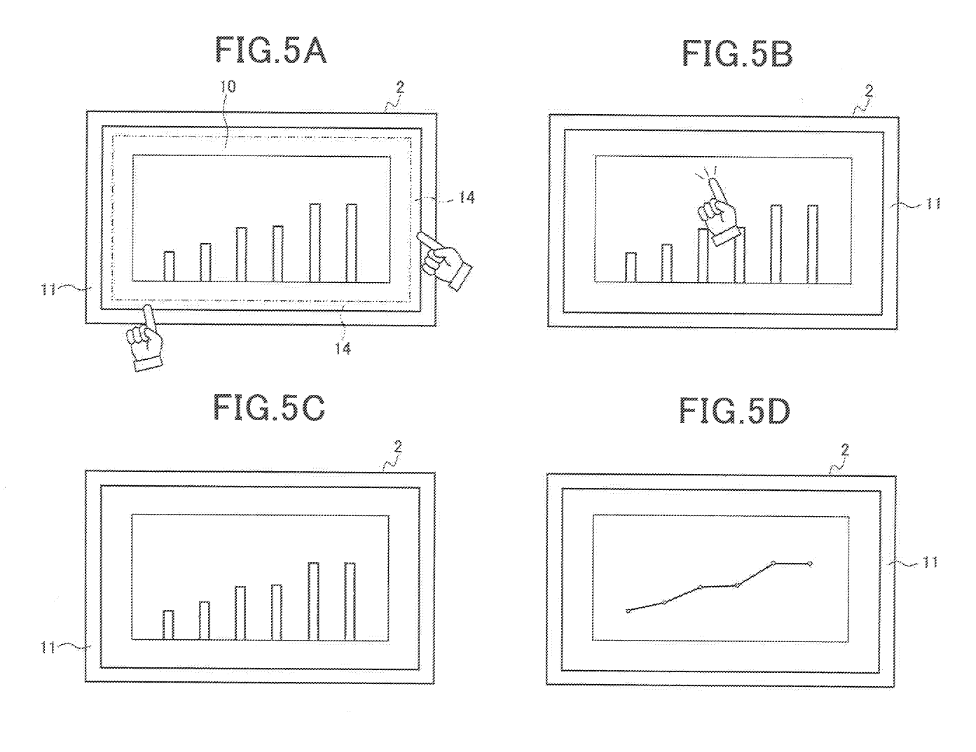

Alternatively, as shown in FIG. 5A, in a case where the fixing mode is set by touching the mode switch button 14, as shown in FIG. 5B, for example, even when the center position of the touch panel 2 is subjected to single tap with the finger of the user and this state is detected by the touch judging portion 22, the mode setting portion 23 does not give an instruction of, for example, processing for shifting the display content at the time when the fixing mode is set to display content of a next page to the image edit portion 24. Thus, even when the touch panel 2 is subjected to single tap, the display content of the touch panel 2 is not changed from the display content at the time when the fixing mode is set as shown in FIG. 5C.

In this manner, when the mode switch button 14 is touched, the edit mode is switched to the fixing mode, edit of the display content is prohibited, and the display content at the time when this button 14 is touched is displayed as it is without being changed. Accordingly, even when the touch panel 2 is touched to indicate apart of the display content, the touch to the touch panel 2 is not reflected in the display content, and the current display content does not need to be shifted to the display content of the next page. Thus, it is possible to carry out a presentation using the touch panel 2 smoothly.

Further, when the edit mode is switched to the fixing mode by touching the mode switch button 14, the mode setting portion 23 causes this button 14 to be displayed with a color which is set for the fixing mode (for example, light red) from a color which is set for the edit mode (for example, light blue) (step S104 of FIG. 3). By displaying the edit mode and the fixing mode with a different color, the user is able to easily recognize the current mode.

On the other hand, when the operation mode which is currently set is the fixing mode (NO at step S102 of FIG. 3), the mode setting portion 23 switches to the edit mode (step S105). The display content which has been locked by setting of the fixing mode becomes possible to be edited based on the touch to the touch panel 2.

Thereby, as shown in FIG. 4C, when the finger of the user continuously touches the touch panel 2, for example, in the obliquely right downward direction from the center position, the mode setting portion 23 gives an instruction of processing for the display content to the image edit portion 24 and, for example, a line is written at a position touched with the finger continuously.

Alternatively, in a case where the edit mode is set, as shown in FIG. 5B, for example, when the center position of the touch panel 2 is subjected to single tap with the finger of the user, the mode setting portion 23 gives an instruction of processing prescribed for single tap at this position to the image edit portion 24, and, for example, as shown in FIG. 5D, display content of a next page is able to be displayed.

Note that, when the fixing mode is switched to the edit mode, the mode switch button 14 is displayed with the color which is set for the edit mode (for example, light blue) from the color which is set for the fixing mode (for example, light red) (step S106 of FIG. 3).

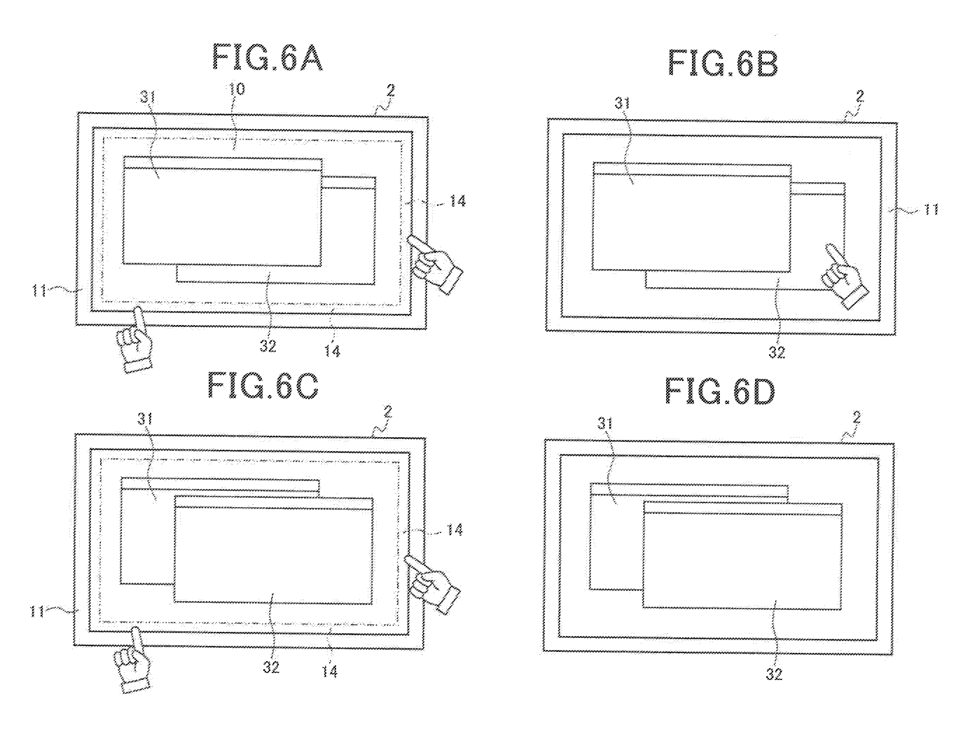

Alternatively, as shown in FIG. 6A, in a case where a first window 31 is displayed in front of a second window 32 on the touch panel 2 and the fixing mode is set, when the user touches the mode switch button 14, the mode is switched to the edit mode. Subsequently, as shown in FIG. 6B, when the user touches an area inside of the mode switch button 14, for example, the second window 32, this second window 32 is displayed in front of the first window 31.

Subsequently, as shown in FIG. 6C, when the user touches the mode switch button 14, the mode is switched to the fixing mode. Thereby, even when the user touches not only the second window 32 but the first window 31 at the time of explaining the second window 32, as shown in FIG. 6D, the second window 32 remains displayed in front of the first window 31 and, moreover, the content of the touch is not reflected.

In this manner, each time the mode switch button 14 is touched, it is possible to easily switch between the edit mode and the fixing mode. Thus, generally, even if the edit mode is set, when it is desired to make an explanation while indicating current display content, the fixing mode is set by touching the mode switch button 14. Thereafter, such as when it is desired to make an explanation by inputting a line or the like to the current display content or when it is desired to move to a next page, the edit mode may be set by touching the mode switch button 14.

Note that, description has been given with an example in which the mode switch button 14 is identified with a color in the above-described embodiment. However, when the fixing mode is set, for example, the mode switch button may be displayed in a pattern such as diagonal line, or characters of the “fixing mode”, symbols or the like may be displayed in a part of the mode switch button.

As above, though description has been given for the embodiment of the present invention, the present invention is an information display apparatus having an edit mode capable of editing an image displayed on a touch panel and a fixing mode for prohibiting editing of the displayed image to maintain the image, in which a judging portion for judging whether or not a predetermined position of the touch panel is touched, and a mode setting portion for switching the edit mode and the fixing mode each time it is judged that the predetermined position is touched may be included.

Thereby, when the predetermined position of the touch panel is touched, the edit mode is easily switched to the fixing mode and edit of display content is prohibited to maintain the display content as it is. Therefore, even when the touch panel is touched to indicate apart of the display content, the touch to the touch panel is not reflected in the display content, and the current display content does not need to be shifted to display content of a next page, so that a presentation using the information display apparatus with the touch panel is carried out smoothly. As a result, it is possible to provide the user-friendly information display apparatus.

Moreover, a cabinet which holds a periphery of the touch panel may be included, and the predetermined position of the touch panel may be formed into a belt shape along an outline of the cabinet. This makes it possible to touch the predetermined position of the touch panel no matter what position the user is with respect to the display apparatus.

Moreover, the predetermined position of the touch panel is able to be displayed in a different form between the edit mode and the fixing mode. In this manner, by displaying the edit mode and the fixing mode in different colors, the user is able to easily recognize the current mode.

As above, according to the present invention, when the predetermined position of the touch panel is touched, the edit mode is easily switched to the fixing mode and edit of display content is prohibited to maintain the display content as it is. Therefore, even when the touch panel is touched to indicate a part of the display content, the touch is not reflected in the display content, and the current display content does not need to be shifted to display content of a next page, so that a presentation using the touch panel is carried out smoothly. As a result, it is possible to provide the user-friendly information display apparatus.

1. An information display apparatus having an edit mode capable of editing an image displayed on a touch panel and a fixing mode for prohibiting editing of the displayed image to maintain the image, wherein
a judging portion for judging whether or not a predetermined position of the touch panel is touched, and a mode setting portion for switching the edit mode and the fixing mode each time it is judged that the predetermined position is touched are included.

2. The information display apparatus as defined in claim 1, wherein
a cabinet which holds a periphery of the touch panel is included, and the predetermined position of the touch panel is formed into a belt shape along an outline of the cabinet.

3. The information display apparatus as defined in claim 1, wherein
the predetermined position of the touch panel is displayed in a different form between the edit mode and the fixing mode.
